(19) United States
(12) Patent Application Publication
(10) Pub. No.: US 2019/0297852 A1
(43) Pub. Date: Oct. 3, 2019

(54) Triple Pet Leash

(71) Applicant: Preston Mann, Denver, CO (US)

(72) Inventor: Preston Mann, Denver, CO (US)

(21) Appl. No.: 16/372,669

(22) Filed: Apr. 2, 2019

Related U.S. Application Data
(60) Provisional application No. 62/651,984, filed on Apr. 3, 2018.

(51) Int. Cl. A01K 27/00

(52) U.S. Cl. CPC A01K 27/003; A01K 27/004; A01K 27/005

(57) ABSTRACT

Novel tools and techniques for a multiple pet restraint are provided. A system includes a main line having a proximate end and a distal end, three or more lead lines, each of the three or more lead lines having a respective proximate end and a respective distal end, and a swivel assembly configured to prevent the three or more lead lines from becoming entangled. The swivel assembly further includes a main line connector and a lead connector. The main line connector and the lead connector are configured to rotate independently about an at least one axis, and to allow the three or more lead lines to rotate about the at least one axis independent of the main line.

### CROSS-REFERENCES TO RELATED APPLICATIONS

This application claims priority to U.S. Patent Application Ser. No. 62/651,984 (the “'984 application”), filed Apr. 3, 2018 by Preston Mann (attorney docket no. 1005.03PR), entitled, “Triple Pet Leash,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to animal restraints, such as leashes and the like; and more particularly, to restraints which allow unfettered control by a single handler of multiple animals without entanglement.

### BACKGROUND

Paid assistants and pet sitters often walk multiple pets simultaneously. Over half of dog owners own more than one dog. More than ever, multiple pets travel with their owners. One of the primary problems in walking multiple pets is the variant height of each animal, as well as varying heights of the handlers. In addition, multiple animals on single tether systems tend to wander in each other's path causing the lines to entangle.

Pet owners or handlers having multiple pets, such as dogs, often have trouble walking multiple pets simultaneously without the leashes becoming entangled. For example, if one dog on the left leash decides to switch to the right side, behind or in front, of the other two dogs on a leash, the leashes will most likely become entangled. Similarly, the leashes can entangle the person walking the multiple pets, for example, if one dog decides to go around the pet owner, thereby entangling the legs of the pet owner as well as the leash of the other dogs. Likewise, three dogs of differing height present a problem if walked together, as the dogs will be at differing distances from the owner.

Thus, novel tools and techniques for a multiple pet restraint are provided.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a multiple pet restraint, in accordance with various embodiments;

FIG. 2A illustrates a perspective view of a swivel assembly for a multiple pet restraint, in accordance with various embodiments;

FIG. 2B illustrates another perspective view of a swivel assembly for a multiple pet restraint, in accordance with various embodiments; and

FIG. 3 is an alternative swivel assembly for a multiple pet restraint, in accordance with various embodiments.

### DETAILED DESCRIPTION OF CERTAIN EMBODIMENTS

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or apparatuses. Merely by way of example, a method might comprise one or more procedures, any or all of which are performed with a system or apparatus. Correspondingly, an embodiment might provide a system or apparatus for performing one or more procedures in accordance with methods provided by various other embodiments.

A need for pet handlers and owners to be able to restrain and/or walk multiple pets simultaneously has been identified. It has been determined to be advantageous to have a multiple pet restraint with an adjustable handle portion, as well as adjustable pet leads. The multiple pet restraint may include a swivel assembly for coupling one end of a main line of the handle portion to a proximate end of three or more pet lead lines. The swivel assembly may include a circular member configured to rotate freely around at least one axis of the swivel assembly, and to prevent the three or more pet lead lines from becoming entangled, restricted, or restrained in multiple directions.

In an aspect, a multiple pet restraint is provided. The multiple pet restraint may include a main line, held by the handler, and three or more lead lines, for attachment to the animals, and a swivel assembly configured to couple the main line to the three or more lead lines. The swivel assembly may include a main line connector and lead connector, wherein the main line connector and lead connector are configured to be rotatable about an at least one axis, wherein each of the main line connector and lead connector are configured to rotate independently about the at least one axis. The main line connector may be configured to be coupled to the main line. The lead connector may be configured to be coupled to each of the three or more lead lines.

In some examples, the lead connector may include a bottom member, to which each of the three or more lead lines may be coupled. The bottom member may be coupled via one or more rigid arms, to a top member. The bottom member may be a flat, circular member with a hole in the center through which the three or more lead lines may pass. The top member may be a flat, circular member with a smaller circumference (e.g., diameter) than the bottom member. The top member may include a hole in the center, through which the main line connector may pass and be coupled to the lead connector. The bottom member may be configured to allow each of the three or more lead lines to both slide circumferentially around the circular member, and to rotate about the at least one axis, independent of the main line connector. Thus, the swivel assembly may be configured to allow the three or more lead lines to create a multi-planed 180 degrees of freedom arc without entanglement of the three or more lead lines.

The main line connector may further include a top portion and bottom portion fixedly coupled via a vertical member. The main line connector may be coupled to the lead connector via the top member of the lead connector. The vertical member of the main line connector may pass through the hole in the center of the top member and may be rotatably coupled to the top member of via the bottom portion. The bottom portion may be circular and flat, with a circumference smaller than the top member. Thus, the bottom portion may be attached, via the vertical member passing through the hole in the center of the top member, to the top portion. The top portion may be coupled to the main line.

In some examples, the main line may have a proximate end and a distal end, wherein the proximate end includes a handle, loop, or other securing mechanism. The distal end of the main line may be configured to be coupled to the main line connector of the swivel assembly. Similarly, each of the three or more lead lines may include a respective proximate end and distal end. The proximate end of a lead line may be configured to be coupled to the lead connector of the swivel assembly, while the distal end may be configured to be coupled to a collar, harness, or other restraint of an animal.

In some examples, the main line, or three or more lead lines, may be adjustable in length. The three or more lead lines may further include, at their respective distal ends, respective swiveled snap hooks configured to couple to an animal restraint, such as a collar or harness. In further examples, the top portion of the main line connector may alternatively comprise a “D” shaped ring coupled to the main line. The top portion may further be rotatable around the at least one axis. In some examples, the at least one axis may be defined by a longitudinal axis of the vertical member. In some examples, the top member of the lead connector may include three or more respective slots configured to receive the three or more lead lines. The lead connector may, in some further examples, include a single member, configured to be coupled to each of the three or more lead lines, and further to be rotatably coupled to the main line connector. The multiple pet restraint may include further features, some which may be described in U.S. Pat. No. 6,626,132, by Scott K. Mann, entitled “Multiple Pet Leash,” the disclosures of which are hereby incorporated in its entirety for all purposes.

Various modifications and additions can be made to the embodiments discussed without departing from the scope of the invention. For example, while the embodiments described above refer to specific features, the scope of this invention also includes embodiments having different combination of features and embodiments that do not include all the above described features.

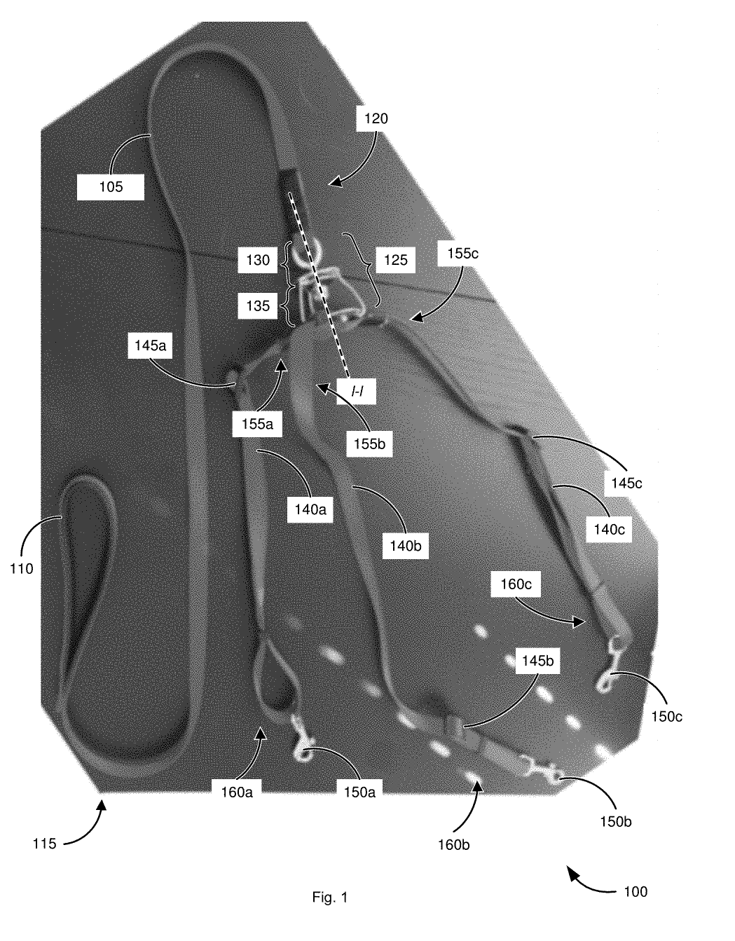

FIG. 1 is a multiple pet restraint 100, in accordance with various embodiments. The multiple pet restraint 100 includes a main line 105 with a handle portion 110, the main line 105 including a proximal end 115 and a distal end 120, a swivel assembly 125, main line connector 130, lead connector 135, a first lead line 140a, second lead line 140b, and third lead line 140c (collectively referred to as “lead lines 140”), a first line length adjuster 145a, second line length adjuster 145b, and third line length adjuster 145c (collectively referred to as “line length adjusters 145”), a first connector 150a, second connector 150b, and third connector 150c (collectively referred to as “connectors 150”), each of the lead lines 140 including, respectively, a first proximal end 155a, second proximal end 155b, third proximal end 155c, first distal end 160a, second distal end 160b, and third distal end 160c. It should be noted that the specific components of the multiple pet restraint 100 and associated components are provided by way of example only, and that modifications to multiple pet restraint 100 may be possible in accordance with various embodiments.

In various embodiments, the main line 105 may include a handle portion 110 at a proximal end 115. The main line 105 may be coupled, at a distal end 120, to a main line connector 130 of the swivel assembly 125. Accordingly, the swivel assembly 125 may include the main line connector 130, coupled to the distal end 120 of the main line 105, and a lead connector 135 coupled to the lead lines 140. The lead lines 140 may each be coupled to the lead connector 135 at a respective proximal end 155a-155c. Each of the lead lines 140 may include respective line length adjusters 145, and connectors 150 at a respective distal ends 160a-160c.

In various embodiments, the main line 105 may be a flexible line. The main line 105 may take various form factors, such as, without limitation, a strap, cord, rope, string, cable, or ribbon. In some embodiments, the main line 105 may be elastic or non-elastic. The main line 105, in some embodiments, may be a loose or free strap, that may hang freely from the handle 110, or wrapped around a hand, for example. In some embodiments, the main line 105 may be wound around a guide, such as a spring-loaded guide, and may be extendable and retractable. In yet further embodiments, the length of the main line 105 may be adjustable via a line length adjuster, such as the line length adjusters 145 of the lead lines 140.

In various embodiments, the handle 110 may be configured to allow a user of the leash, such as a pet owner or handler, to manipulate and/or control the multiple pet restraint 100. In some embodiments, the handle 110 may be a loop created within the main line 105. In other embodiments, the handle 110 may include a handle assembly, which may include, for example, a housing for a spring-loaded guide. In further embodiments, the handle 110 may include a rigid handle coupled to the main line 110, such as, without limitation, a ring, triangle, oval, or a handle bar.

In various embodiments, the main line 105 may be coupled, at a distal end 120, to a swivel assembly 125. The swivel assembly 125 may include a main line connector 130 and a lead connector 135. Accordingly, the main line 105 may be coupled, at the distal end 120, to the main line connector 130 of the swivel assembly 125. In some embodiments, the main line connector 130 may include a top portion coupled to a bottom portion via a vertical member. In some embodiments, the bottom portion may include a flat, substantially round disc-like structure to which the top portion may be coupled via the vertical member. The top portion of the main line connector 130 may include a connector configured to couple to or otherwise receive the distal end 120 of the main line 105. For example, the top portion may include, without limitation, a hook, loop, ring, quick connect or quick release connectors, side release buckles, and other suitable connector. Thus, in some embodiments, the main line 105 may be removably attached to the top portion of the main line connector 130. In other embodiments, the main line 105 may be fixedly attached to the top portion of the main line connector 130.

In various embodiments, the main line connector 130 may be coupled to a lead connector 135. For example, in some embodiments, a bottom portion of the main line connector 130 may be configured to be coupled to the lead connector 135. For example, in some embodiments, the lead connector 135 may include a top member and a bottom member. The bottom portion of the main line connector 130 may be positioned between the top member and bottom member such that the bottom portion of the main line connector 130 is kept in position between the top member and the bottom member of the lead connector 135. In some embodiments, at least part of the vertical member, coupling the top portion and the bottom portion, may be configured to pass through the top member of the lead connector 135, thus rotatably coupling the main line connector 130 to the lead connector 135. For example, in some embodiments, the main line connector 130 and lead connector 135 may be configured to rotate independently about at least one axis, such as axis l-l. In some other embodiments, the bottom portion of the main line connector 130 may be rotatably coupled to the lead connector 135, for example, via a bearing. For example, suitable bearings may include various types of plain bearings, ball bearings, fluid bearings, jewel bearing, among other types of suitable bearings. The bearings may be configured to rotate about the axis l-l, allowing the main line connector 130 and lead connector 135 to rotate independently of each other. In operation, the main line connector 130 and lead connector 135 may be configured to articulate 360 degrees about the axis l-l. Thus, the swivel assembly 125 may be configured to allow each of the lead lines 140 to move and rotate freely, relative to each other without becoming entangled. Thus, while the animals and lead lines are in front of a plane defined to be orthogonal to the axis l-l, the swivel assembly 125 may prevent entanglement of one or more of the lead lines 140a-140c.

In various embodiments, the lead connector 135 may be configured to be coupled to three or more lead lines 140 at a respective proximal end 155a-155c. In some embodiments, each of the three or more lead lines 140 may be coupled to the lead connector 135. In some embodiments, each of the three or more lead lines 140 spaced substantially equidistantly from each other. Alternatively, the lead connector 135 may be configured to keep each of the three or more lead lines within a given range of distances from each other, such that no two lead lines 140 become too close or become too separated. For example, in some embodiments, the lead connector 135 may include a bottom member coupled to the top member via one or more arms, and the three or more lead lines 140 may be coupled to the bottom member. The one or more arms may be configured to separate, or otherwise maintain spacing between the lead lines 140.

In various embodiments, the lead connector 135 may include a connection point for the at least one of the lead lines 140. For example, in some embodiments, the lead connector 135 may include a centered hole through which the proximal ends 155a-155c of the lead lines 140 may pass through and be coupled to the lead connector 135. In some examples, the proximal ends 155a-155c of the lead lines 140 may include hooks, loops, rings, quick connect or quick release connectors, side release buckles, and other suitable connectors for coupling to the lead connector 135. In further embodiments, the lead connector 135 may include one or more connection points configured to couple with the one or more lead lines 140. For example, the one or more connection points may include respective slots for each proximal end 155a-155c of the lead lines 140. The slots may be equally spaced circumferentially around the lead connector 135.

In some embodiments, the lead connector 135, or alternatively, a bottom member of the lead connector 135, may include a flat, substantially round disc-like structure. In yet further embodiments, the top member of the lead connector 135 may also include a flat, substantially round disc-like structure. In some embodiments, the top member may be a disc-like structure with a smaller diameter than the bottom member, which may also be a disc-like structure.

In some embodiments, the lead connector 135 may be configured to allow the proximal ends 155a-155c of the three or more lead lines 140 to slide circumferentially around the lead connector 135, or alternatively, a bottom member of the lead connector 135. In alternative embodiments, the lead connector 135 may be configured to restrict movement circumferentially around the lead connector 135 and/or bottom member of the lead connector 135. For example, the one or more lead lines 140 may be fixedly attached to the lead connector 135, or in some embodiments, the one or more slots to which the one or more lead lines 140 may be coupled may be configured to restrict a range of movement circumferentially around the lead connector 135.

In various embodiments, the lead lines 140 may, similar to the main line 105, include a flexible line. The lead lines 140 may take various form factors, such as, without limitation, a strap, cord, rope, string, cable, or ribbon, and may further be elastic or non-elastic. In some embodiments, the respective lengths of each of the three or more lead lines 140 may be adjustable via a respective line length adjuster 145a-145c. For example, lead line adjusters 145 may include, without limitation, slideable clamps, clips, buckles, among other types of length adjusters.

In some embodiments, the lead lines 140 may be configured to be coupled to a respective animal at the respective distal ends 160a-160b. The animals may thus be tethered to the swivel assembly 125 via respective lead lines 140a-140b, and in turn to the user and/or handler via the main line 105. Thus, in various embodiments, the lead lines 140 may include a respective connector 150a-150c. Suitable connectors 150 may include, without limitations, hooks, loops, rings, quick connect or quick release connectors, side release buckles, and other suitable connectors.

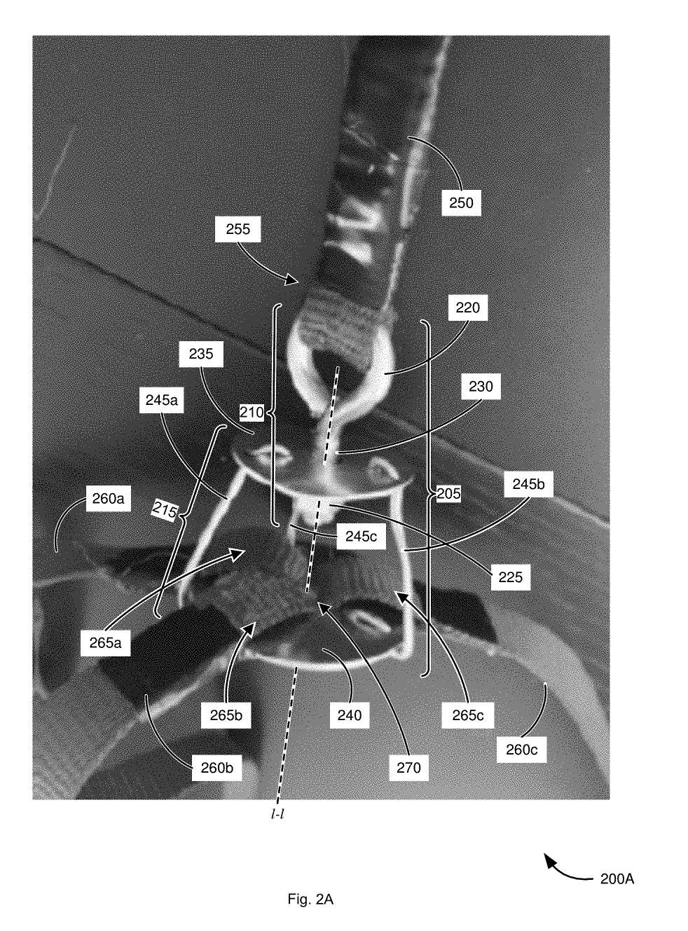

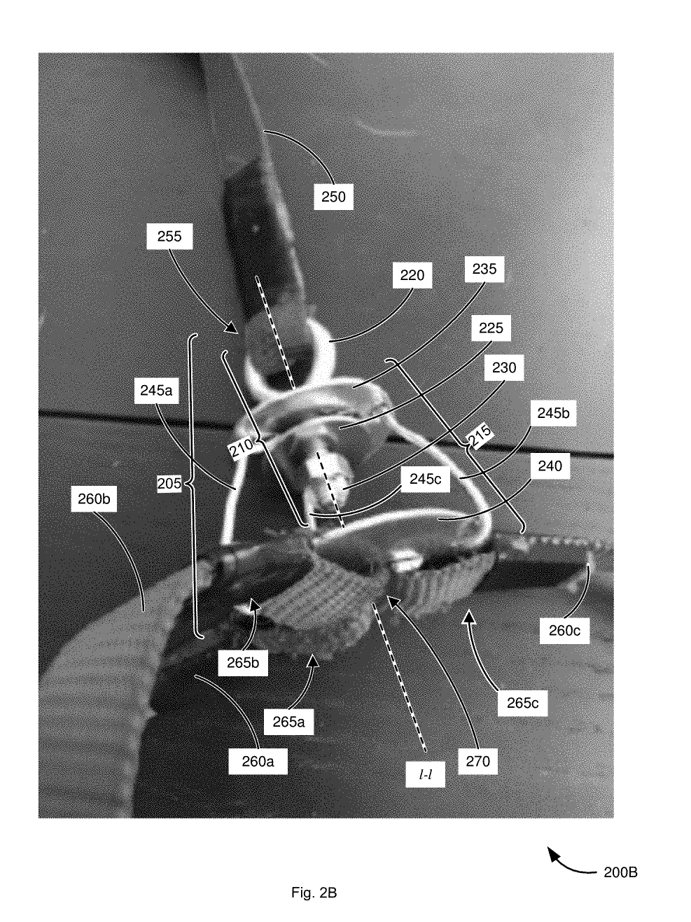

FIG. 2A illustrates a perspective view 200A of a swivel assembly 205 for a multiple pet restraint, in accordance with various embodiments. FIG. 2B illustrates another perspective view 200B of a swivel assembly 205 from a different angle, and in accordance with various embodiments. With reference to both FIGS. 2A & 2B, in various embodiments, the swivel assembly 205 includes a main line connector 210, and a lead connector 215. The main line connector 210 may include a top portion 220, bottom portion 225, and a vertical member 230. The lead connector 215 may include a top member 235, bottom member 240, and a first arm 245a, second arm 245b, and third arm 245c (collectively referred to as the “arms 245”). It should be noted that the specific components of the swivel assembly 205 and associated components are provided by way of example only, and that modifications to the swivel assembly 200 may be possible in accordance with various embodiments.

In various embodiments, the main line connector 210 may be configured to couple to a main line 250. For example, the main line connector 210 may include a top portion 220, configured to couple to a distal end 255 of the main line 250. As previously described, the top portion 220 may include a connector configured to couple to or otherwise receive the distal end 255 of the main line 250. For example, the top portion 220 may include, without limitation, a hook, loop, ring, quick connect or quick release connectors, side release buckles, and other suitable connector. Thus, in some embodiments, the main line 250 may be removably attached to the top portion 220 of the main line connector 210. In other embodiments, the main line 250 may be fixedly attached to the top portion 220 of the main line connector 210.

In various embodiments, the main line connector 210 may be coupled to a lead connector 215. The lead connector 215 may include a top member 235 coupled to a bottom member 240 via one or more control arms 245. As previously described, in some embodiments, the vertical member 230 of the main line connector 210 may be configured to pass through a top member 235 of the lead connector 215, such that a bottom portion 225 of the main line connector 210 is positioned between the top member 235 and bottom member 240. Thus, the main line connector 210 may be rotatably coupled to the lead connector 135. In various embodiments, the main line connector 210 and lead connector 215 may be configured to rotate about axis l-l independently from each other.

In some embodiments, the bottom portion 225 of the main line connector 210 may be rotatably coupled to the lead connector 215, for example, via a washer kept in place via a nut, in which rotation causes the surfaces of the bottom portion 225 and the top member 235 of the lead connector 215 to slide against each other. In other embodiments, the one or more arms 245 may be configured to create a gap between the bottom portion 225 and the top member 235, and to reduce a surface area in contact with the bottom portion 225 to further facilitate rotation. In further embodiments, the bottom portion 225 may be coupled to the lead connector 215 via a bearing, as previously described.

In various embodiments, the lead connector 215 may be configured to be coupled to the lead lines 260 at a respective proximal end 265a-265c. In some embodiments, each of the three or more lead lines 260a-260c may be coupled to the bottom member 240 of the lead connector 215. In some embodiments, each of the lead lines 260a-260c may be spaced substantially equidistantly from each other, via the one or more arms 245a-245c. For example, in some embodiments, the top member 235 may be coupled to the bottom member 240 via the arms 245. The arms 245 may be configured to maintain a position of each of the lead lines 260 relative to one another. In various embodiments, the bottom member 240 may include a connection point 270 for at least one of the lead lines 260. For example, in some embodiments, the connection point 270 may include a centered hole through which the proximal ends 265a-265c of the lead lines 260 may pass through and be coupled to the bottom member.

In some embodiments, the bottom member 240 of the lead connector 215 may include a flat, substantially round disc-like structure. In yet further embodiments, the top member 235 of the lead connector 215 may also include a flat, substantially round disc-like structure. In some embodiments, the top member 235 may be a disc-like structure with a smaller diameter than the bottom member 240, which may also be a disc-like structure.

Thus, the swivel assembly 205 may be configured to allow each of the lead lines 260 to move and rotate freely, relative to each other without becoming entangled. Thus, while the animals and lead lines are in front of a plane defined to be orthogonal to the axis l-l, the swivel assembly 205 may prevent entanglement of one or more of the lead lines 260a-260c.

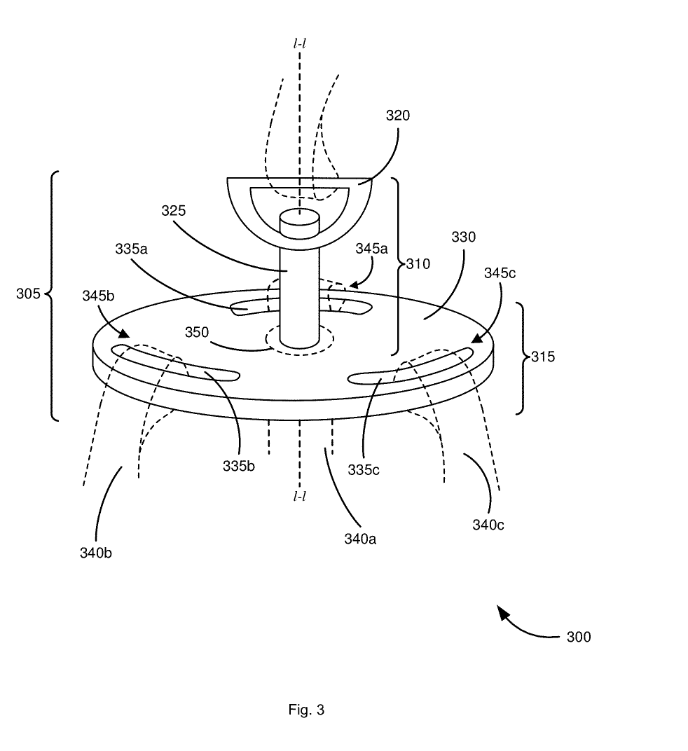

FIG. 3 is a perspective view 300 of an alternative swivel assembly 305 for a multiple pet restraint, in accordance with various embodiments. The swivel assembly 305 may include a main line connector 310 and a lead line connector 315. The main line connector 310 may include a top portion 320, vertical member 325, and a bottom portion (not shown). The lead connector 315 may include a disc-like body 330 including a first lead connector slots 345a, second lead connector slot 345b, and third lead connector slot 345c (collectively “lead connector slots 345”). It should be noted that the specific components of the swivel assembly 300 and associated components are provided by way of example only, and that modifications to the swivel assembly 300 may be possible in accordance with various embodiments.

In various embodiments, the main line connector 310 may be coupled to the lead connector 315 at connection point 350. In various embodiments, the connection point 350 may be a hole centered in the body 330 of the lead connector 315, configured to receive a vertical member 325 of the main line connector 310. In further embodiments, the connection point 350 may include a bearing. For example, suitable bearings may include various types of plain bearings, ball bearings, fluid bearings, jewel bearing, among other types of suitable bearings. The bearings may be configured to rotate about the axis l-l, allowing the main line connector 310 and lead connector 315 to rotate independently of each other.

The main line connector 310 may include a top portion 320 configured to couple to a main line. The top portion 320 may include, as depicted, a D-shaped ring configured to receive and/or couple to a distal end of a main line. In some embodiments, alternatively or additionally to the connection point 350, the connection between the top portion 320 and vertical member 325 may allow the top portion 320 to rotate independently of the vertical member 325 and/or lead connector 315.

The lead connector 315 may include lead connector slots 345 configured to be coupled to a respective proximal end 345a-345c of each of the lead lines 340. The lead connector slots 345 may be configured to maintain each of the lead lines 340 within a range of distances between one another, thus preventing the proximal ends 345a-345c of any two lead lines 340 from becoming too close or too distant from each other.

Thus, the swivel assembly 305 is an alternative embodiment, which may be configured to allow each of the lead lines 340 to move and rotate freely, relative to each other without becoming entangled.

While certain features and aspects have been described with respect to exemplary embodiments, one skilled in the art will recognize that numerous modifications are possible. Further, while various methods and processes described herein may be described with respect to certain structural and/or functional components for ease of description, methods provided by various embodiments are not limited to any single structural and/or functional component, but instead can be implemented on any suitable components. Similarly, while certain functionality is ascribed to certain components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structure and/or with respect to one system may be organized in alternative structures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system comprising:
a main line having a proximate end and a distal end;
three or more lead lines, each of the three or more lead lines having a respective proximate end and a respective distal end;
a swivel assembly configured to prevent the three or more lead lines from becoming entangled, the swivel assembly comprising:
a main line connector further comprising a top portion and a bottom portion, wherein the top portion and the bottom portion are coupled via a vertical member, the top portion configured to couple to the main line; and
a lead connector comprising at least one member coupled to the bottom portion of the main line connector;
wherein the main line connector and the lead connector are configured to rotate independently about an at least one axis, and to allow the three or more lead lines to rotate about the at least one axis independent of the main line.

2. The system of claim 1, wherein:
the at least one member of the lead connector comprises a top member and a bottom member;
the top member is coupled, via one or more arms, to the bottom member;
the top member is configured to be rotatably coupled to the bottom portion of the main line connector; and
the bottom member is configured to be coupled to the three or more lead lines.

3. The system of claim 2, wherein:
the bottom member has a substantially flat and circular structure;
the top member has a substantially flat and circular structure with a smaller circumference than the bottom member;
the top member further includes an opening in a center of the top member;
the bottom portion of the main line connector has a substantially flat and circular structure with a smaller circumference than the top member of the lead connector; and
the vertical member of the main line connector passes through the opening of the top member and is rotatably coupled to the top member such that the bottom portion is positioned between the top member and the bottom member.

4. An apparatus comprising
a swivel assembly configured to prevent the three or more lead lines from becoming entangled, the swivel assembly comprising:
a main line connector further comprising a top portion and a bottom portion, wherein the top portion and the bottom portion are coupled via a vertical member, the top portion configured to couple to a main line; and
a lead connector comprising at least one member coupled to the bottom portion of the main line connector;
wherein the main line connector and the lead connector are configured to rotate independently about an at least one axis, and to allow three or more lead lines to rotate about the at least one axis independent of the main line.

5. The apparatus of claim 4, wherein:
the at least one member of the lead connector comprises a top member and a bottom member;
the top member is coupled, via one or more arms, to the bottom member;
the top member is configured to be rotatably coupled to the bottom portion of the main line connector; and
the bottom member is configured to be coupled to the three or more lead lines.

6. The apparatus of claim 5, wherein:
the bottom member has a substantially flat and circular structure;
the top member has a substantially flat and circular structure with a smaller circumference than the bottom member;
the top member further includes an opening in a center of the top member;
the bottom portion of the main line connector has a substantially flat and circular structure with a smaller circumference than the top member of the lead connector; and
the vertical member of the main line connector passes through the opening of the top member and is rotatably coupled to the top member such that the bottom portion is positioned between the top member and the bottom member.

7. A method comprising:
connecting a main line, having a proximate end and a distal end, to a top portion of a main line connector of a swivel assembly;
coupling a bottom portion of the main line connector to a lead connector of the swivel assembly such that the lead connector is free to rotate about an at least one axis independent of the bottom portion;
coupling three or more lead lines to the lead connector; and
allowing the three or more lead lines to rotate about the at least one axis independent of the main line.

8. The method of claim 7, further comprising:
coupling the three or more lead lines to a bottom member of the lead connector;
rigidly coupling, via one or more arms, the bottom member to a top member of the lead connector;
rotatably coupling the top member of the lead connector to the bottom portion of the main line connector.

9. The method of claim 8, wherein coupling the bottom portion of the main line connector further comprises:
passing a vertical member, rigidly coupling the bottom portion to the top portion, through a hole in the center of the top member of the lead connector; and
positioning the bottom portion between the top member and the bottom member.
